(19) United States
(12) Patent Application Publication
(10) Pub. No.: US 2014/0080344 A1
(43) Pub. Date: Mar. 20, 2014

(54) CARD EDGE CONNECTOR

(71) Applicant: SPEED TECH CORP., Taoyuan Hsien (TW)

(72) Inventors: Josue CASTILLO, TAOYUAN HSIEN (TW); James Patrick YOUNG, TAOYUAN HSIEN (TW); Li-Sen CHEN, TAOYUAN HSIEN (TW); Yen-Jang LIAO, TAOYUAN HSIEN (TW); Pei-Lei TU, TAOYUAN HSIEN (TW)

(73) Assignee: SPEED TECH CORP., TAOYUAN HSIEN (TW)

(21) Appl. No.: 13/719,234

(22) Filed: Dec. 19, 2012

(30) Foreign Application Priority Data
Sep. 18, 2012 (TW) 101218066

(51) Int. Cl. H01R 12/16

(52) U.S. Cl. CPC H01R 23/7015
USPC 439/327

(57) ABSTRACT

The invention relates to a card edge connector including an insulating body, a first fixing part, a second fixing part and a plurality of terminals. The terminals are respectively fixing on the first fixing part and the second fixing part in an insert molding manner. The first fixing part and the second fixing part are received and arranged in the insulating body. The first fixing part and the second fixing part respectively has at least one hook. At least one insertion slot is inwardly formed in the insulating body at a position corresponding to the hook; and the hooks are respectively pushed and fastened inwards towards the insertion slots, so that the first fixing part and the second fixing part are assembled and located on the insulating body.

### RELATED APPLICATIONS

This application claims priority to Taiwan application Serial Number 101218066, filed Sep. 18, 2012, which is herein incorporated by reference.

### BACKGROUND

1. Field of Invention

The invention relates to a card edge connector. More particularly, the invention relates to a card edge connector applied to a memory card module, a display card module, a solid hard disk module or a WLAN card (wireless local area network card) module.

2. Description of Related Art

Card edge connectors applied to a memory card module, a network is interface card module, a multi-media player module or a GPS (global position system) module and the like of a desktop computer, a notebook computer or other portable multi-media players are usually difficult to conform to the standard specification of high frequency signals as signals interfere with each other due to a large number of terminals. In addition, as the terminals are miniaturized, the assembly of the card edge connector with an insulating body tends to be difficult in production.

In the prior art, generally, after an insulating body is formed by plastic ejection processing, terminals are respectively inserted into insertion holes of the insulating body. As the number of the terminals is large, the dimension and space of the insulating body is limited, and the space between the terminals is too tight, the space of barriers between the terminals is too small. When the terminals are assembled respectively, fracture and damage of the barriers is likely to occur due to the push of external gravity, and the terminals tend to withdraw. In addition, the terminal itself is not a well-designed elastic structure, and after a butt-joint module is plugged in the insulating body for many times, some terminals may not be able to provide enough elasticity to the butt-joint module, therefore having effects on the quality of signals transferred between each other.

Accordingly, in order to improve the defects of the prior art, an electric to card edge connector is provided, wherein a design mode that a terminal is fixing in plastic in an insert molding manner is utilized, so as to fix the terminal in a combination part, and then the combination part is assembled on the insulating body. Since the terminal is fixing on the combination part in an insert molding manner and then is arranged in the insulating body, fracture caused by too short space between harriers of the insulating body when the terminal is assembled in the insulting body is avoided. The terminal is of a good elastic structure by being inserted into plastic and wrapped, so as to improve the stability of signals when the butt-joint modules are butt-jointed.

As shown in FIG. 9, U.S. Pat. No. 8,021,178 provides an electric card edge connector which includes an insulating body 200, a first combination part 300, a plurality of first terminals 400, a second combination part 500, a plurality of second terminals 600 and two clamping parts 700. A butt-joint insertion slot 211 is arranged at the front side of the insulating body 200. The first combination part 300 is assembled at the rear side of the insulating body 200 along a first combination direction Dl. The first terminal 400 is fixing on the first combination part 300 in an insert molding manner and runs through the insulating body 200 to be exposed out of the butt-joint insertion slot 211. The second combination part 500 is combined at the lower side of the insulating body 200 along a second combination direction D2. The second terminal 600 is fixing on the second combination part 500 in an insert molding manner. The first combination direction D1 is vertical to the second combination direction D2. The two clamping parts 700 are arranged at two sides of the insulating body 200 along a direction opposite to the first combination direction D1. The two clamping parts 700 can clamp two sides of the butt-joint module (not shown). The butt-joint module may be a memory card or an electronic card.

However, in the structure of the electric card edge connector, as the side edges of the card of the butt-joint module are clamped by the two clamping parts, when the mutual clamping force of the two clamping parts is insufficient and the butt-joint module is place horizontally, the card may be partially cut. Therefore scraping a precise circuit board on the surface of the butt-joint module. Furthermore, as the clamping parts are frequently used for fixing the butt-joint module, there will be elastic fatigue of the butt-joint module and its effect cannot be realized, and the consuming cost of the parts will be increased, thus causing issues that need to be solved in production.

### SUMMARY

The invention provides a card edge connector. A terminal of the card edge connector is pre-inserted in and emitted from at least one fixing part. The fixing part is then assembled and located on an insulating body. When an electronic card is arranged in the insulting body, the terminal of the card edge connector is not likely to be compressed to withdraw, so as to improve the signal stability of high frequency signals transferred between the card edge connectors.

The card edge connector disclosed by the invention includes an insulating body, a first fixing part, a second fixing part and a plurality of terminals. The plurality of terminals are respectively fixing in the first fixing part and the second fixing part in an insert molding manner. The first fixing part and the second fixing part are received in the insulating body. A long slot and a plurality of insertion slots are concavely formed in the middle of the insulating body. The long slot runs through the insertion slots, and an electronic card can be inserted and located in the long slot. The first fixing part is assembled in the insertion slot from the side surface of the insulating body. The second fixing part is assembled in the insertion slot from the bottom of the insulating body. The first fixing part and the second fixing part are respectively provided with at least one first hook and at least one second hook. At least one insertion slot and at least one second insertion slot are formed inwards in the insulating body at positions corresponding to the first hook and the second hook. The first hook and the second hook are pushed and fastened inwards towards the first insertion slot and the second insertion slot, so that the first fixing part and the second fixing part are assembled and located on the insulating body.

In the invention, in order to assist the fixing parts to be limited on the insulating body, the first fixing part comprises at least one first bulge, and the second fixing part comprises at least one second bulge. At least one first clamping slot and at least one second clamping slot are formed in the insulating body respectively at positions corresponding to the first bulge and the second bulge. The first bulge and the second bulge are respectively received and arranged in the first clamping slot and the second clamping slot. In addition, the first fixing part comprises at least one matching part. The insulating body comprises at least one groove corresponding to the matching part. A guide surface is formed at the front end of the matching part. The guide surface can guide the matching part to enter the groove.

The card edge connector of the invention further includes a pair of ear clips. The ear clips are respectively arranged in a receiving slot of the insulating body in loose fit. In addition, the terminals of the first fixing part and the second fixing part are arranged in an alternated design manner, so that contact parts of all the terminals of the first fixing part and the second fixing part are partially received in the long slot in a mutually symmetric state, thereby being favorable for the electric connection between the electronic card and the plurality of terminals.

The front side of the insulating body in the invention protrudes outwards to form at least one limiting block. The second fixing part is concave inwards at a position corresponding to the limiting block to form at least one limiting slot. The limiting block is received in the limiting slot. The front ends of the first hook and the second hook are respectively provided with an inclined surface obliquely extending downwards and are accordingly guided and assembled in the first insertion slot and the second insertion slot via the inclined surface.

Other applications related to the invention are apparent according to the disclosure of the invention, however, the disclosure of the invention is realized by the mutual fastening of the hooks and the insertion slots, so that the fixing parts can be assembled on the insulating body. Furthermore, via the matched limiting of the bulges and the clamping slots, the fixing parts can be accurately assembled on the insulating body by utilizing automation equipment, thereby effectively improving the overall yield of mass production. The design manners of those skilled in the art by utilizing other similar principles still fall within the scope disclosed by the invention.

### BRIEF DESCRIPTION OF THE DRAWINGS

FIG. 1 is a solid external view of a first view angle of an embodiment of the invention;

FIG. 2 is a solid external view of a second view angle of an embodiment of the invention;

FIG. 3 is a solid external view of a third view angle of an embodiment of the invention;

FIG. 4 is a rear view of the insulating body of an embodiment of the invention;

FIG. 5 is a solid exploded view of the first view angle of an embodiment of the invention;

FIG. 6 is a solid exploded view of the second view angle of an embodiment of the invention;

FIG. 7 is a solid exploded view of the third view angle of an embodiment of the invention;

FIG. 8 is a solid exploded view of a fourth view angle of an embodiment of the invention; and

FIG. 9 is an exploded view disclosed by prior U.S. Pat. No. 8,021,178.

### DETAILED DESCRIPTION

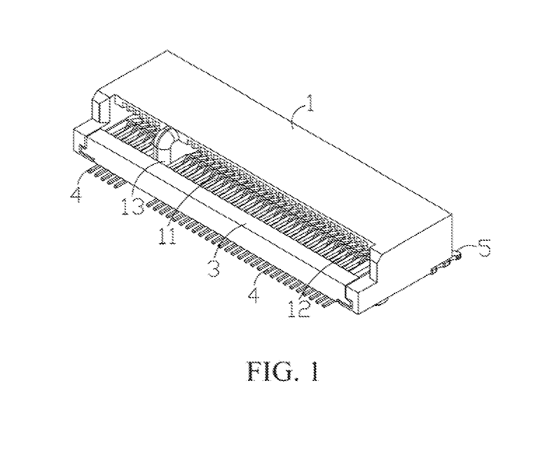

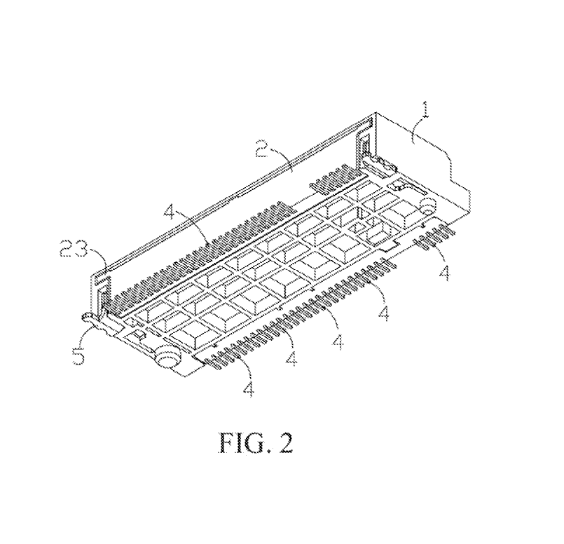

As shown in FIGS. 1 and 2, the invention relates to a card edge connector.

The card edge connector includes an insulating 1, a first fixing part 2, a second fixing part 3, and a plurality of terminals 4. The plurality of terminals 4 are respectively fixing in the first fixing part 2 and the second fixing part 3 in an insert molding manner. The first fixing part 2 and the second fixing part 3 are received and arranged on the insulating body 1. A long slot 11 and a plurality of insertion slots 12 are concavely formed in the middle of the insulating body 1. The long slot 11 runs through the plurality of insertion slots 12, and an electronic card (not shown) such as a memory card, a display card, a sound card or a WLAN (wireless local area network) card can be inserted and located in the long slat 11. The long slot 11 is also provided with a positioning pin 13 in a position corresponding to a positioning bayonet of the electronic card (not shown). The positioning pin 13 is usually located at the non-center position of the long slot 11. In this embodiment, there is one positioning pin 13 being utilized, of course, two or more positioning pins 13 can be designed to meet with the need of the corresponding card. The positioning pin 13 is correspondingly arranged according to a reverse-insertion-prevention device of the electronic card (not shown), that is, the burnout of the electronic card (not shown) caused by mis-installation of the electronic card (not shown) in the long slot 11 is prevented, and the use safety of the electronic card (not shown) is improved. In addition, in order to be matched with the design specification of different electronic products, the positioning pin 13 possibly has various position changes on the insulating body 1, and the dimension and position of the positioning pin 13 can be different due to difference of models and specifications of the connector. In the aspect of the fixing parts, the terminals 4 are welded with laser and then fixing on the fixing parts in an insert molding way, thereby avoiding waste of material cost caused by removal of extra terminals 4.

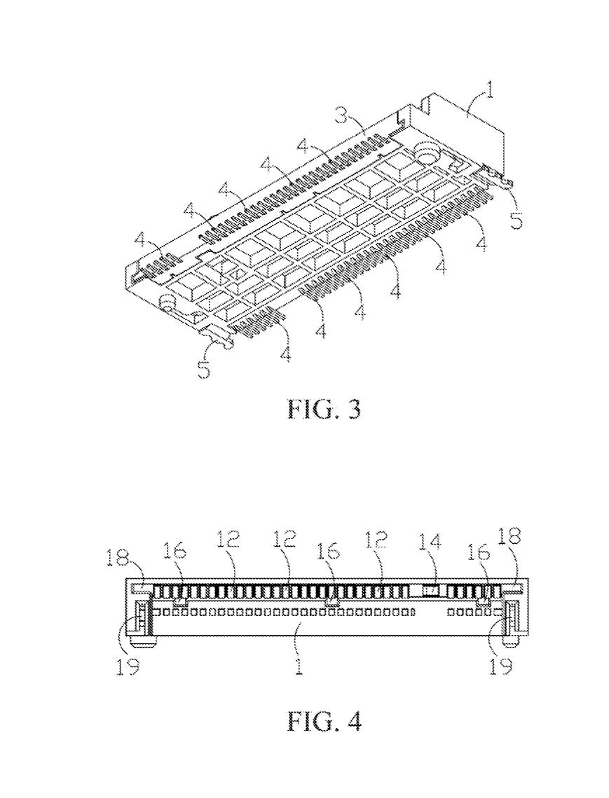

As shown in FIGS. 3-5, in an embodiment of the invention, the first fixing part 2 is assembled on the insertion slot 12 from the side surface of the insulating body 1, and the second fixing part 3 is assembled on the insertion slot 12 from the bottom of the insulating body 1. The first fixing part 2 and the second fixing part 3 are respectively provided with at least one first hook 21 and at least one second hook 31. At least one first insertion slot 14 and at least one second insertion slot 15 are inwardly arranged in the insulating body 1 at positions corresponding to the first hook 21 and the second hook 31. The first hook 21 and the second hook 31 are pushed and fastened inwards towards the first insertion slot 14 and the second insertion slot 15. In addition, the front ends of the first hook 21 and the second hook 31 respectively form an inverted hook shape, so that the first hook 21 and the second hook 31 are not likely to withdraw when being respectively fastened in the first insertion slot 14 and the second insertion slot 15, and the first fixing part 2 and the second fixing part 3 are assembled and located on the insulating body 1. Since the first fixing part 2 and the second fixing part 3 are physically coupled to and interfere with the insulating body 1 due to mutual forcible interference, they are not likely to get separated or fallen off.

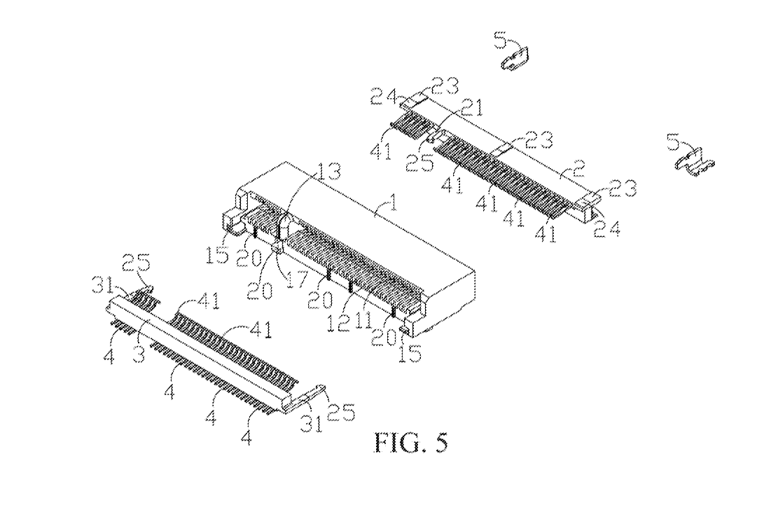

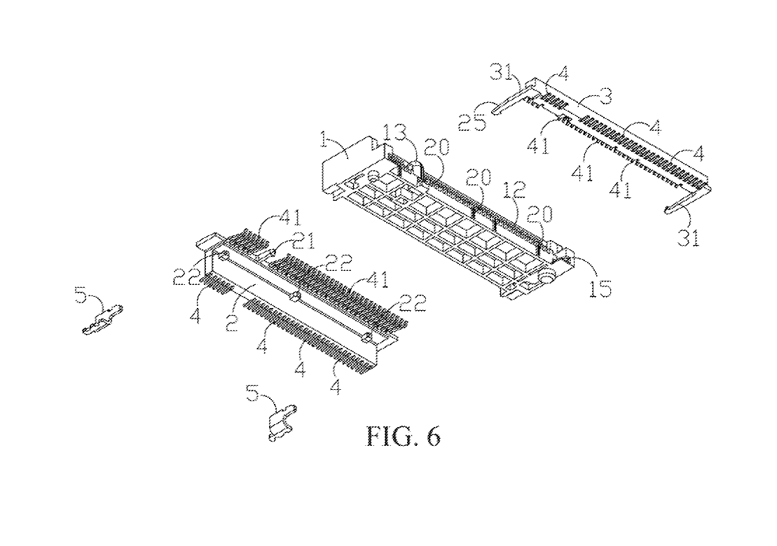

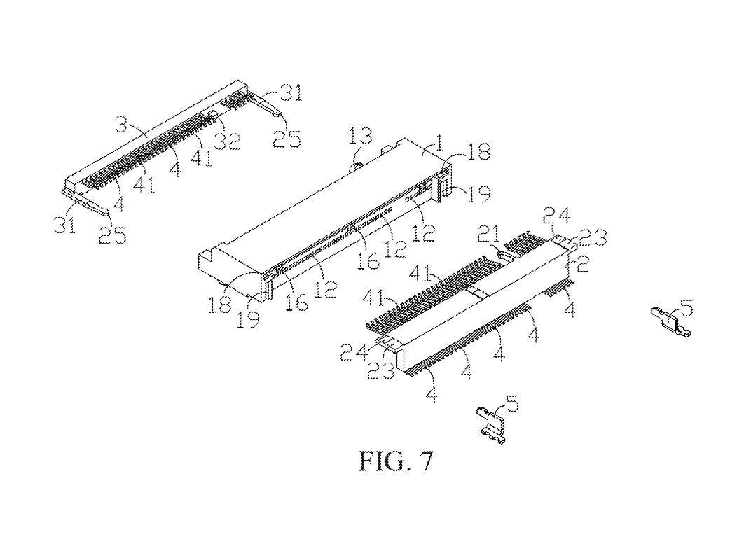

As shown in FIGS. 5-7, in an embodiment of the invention, in order to assist the first fixing part 2 and the second fixing part 3 to be limited on the insulating body 1, the first fixing part 2 comprises at least one first bulge 22, and the second fixing part 3 comprises at least one second bulge 32. At least one first clamping slot 16 and at least one second clamping slot 17 are formed in the insulating body 1 respectively at positions corresponding to the first bulge 22 and the second bulge 32. The first bulge 22 and the second bulge 32 are respectively received and arranged in the first clamping slot 16 and the second clamping slot 17, Since the first bulge 22 and the second bulge 32 as well as the first clamping slot 16 and the second clamping slot 17 are all injection-molded by plastic material, there may be problems due to mutual friction between the bulges and the clamping slots in assembly as the materials are of the same kind. In an embodiment of the invention, the first bulge 22 and the second bulge 32 are respectively designed into a ladder square. Since the ladder square is narrow at the front part and wide at the rear part and obliquely extends downwards, the first bulge 22 and the second bulge 32 can be smoothly assembled and located in the first clamping slot 16 and the second clamping slot 17 respectively. In addition, at least one matching part 23 is arranged on the surface of the first fixing piece 2 in a way of slightly protruding. At least one groove 18 is formed in the insulating body 1 corresponding to the matching part 23. A guide surface 24 is formed at the front end of the matching part 23. The guide surface 24 can guide the matching part 23 to enter the groove 18.

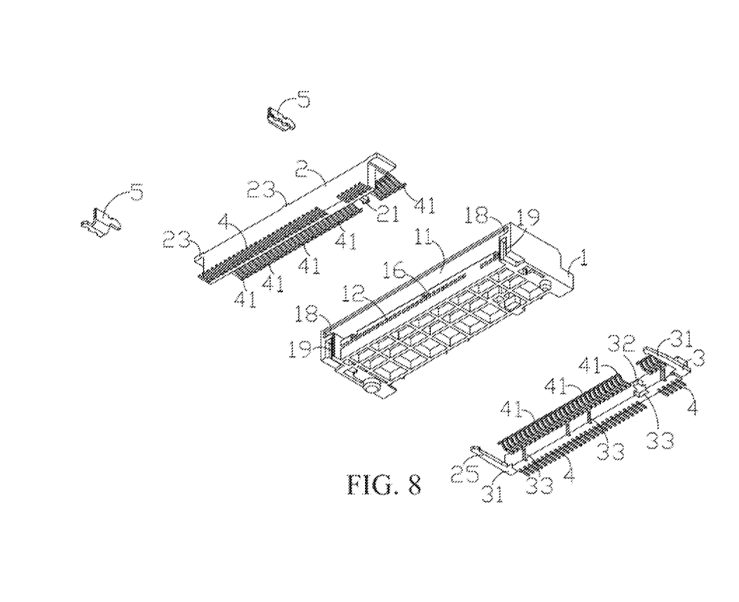

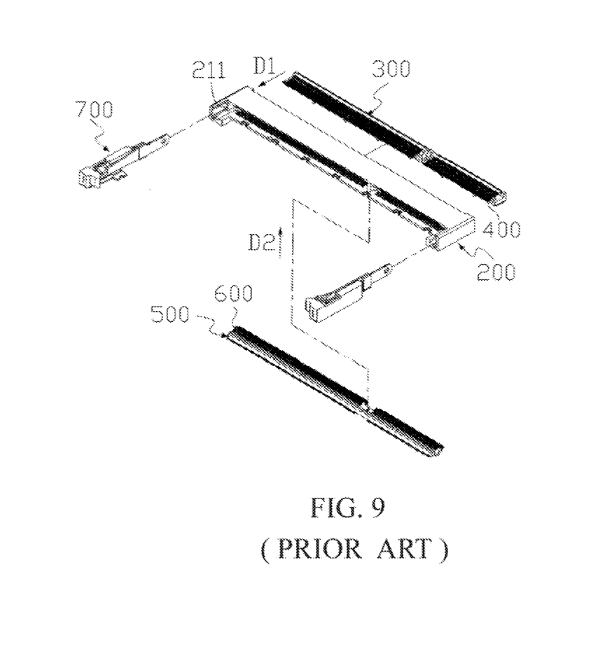

As shown in FIG. 8, in an embodiment of the invention, the card edge connector is additionally provided with a pair of ear clips 5. The ear clips 5 are respectively arranged in a receiving slot 19 at each of two sides of the insulating body 1 in loose fit. In addition, the terminals 4 of the first fixing part 2 and the second fixing part 3 are arranged in alternative design, so that contact parts 41 of all terminals 4 of the first fixing part 2 and the second fixing part 3 are partially received in the long slot 11 in a mutually symmetric state, thereby being favorable for electric connection of the electronic card (not shown) with the plurality of terminals 4. By conducting the electronic card (not shown) and the circuit board (not shown), unidirectional or bidirectional transfer of data between the electronic card and the circuit board can be realized.

As shown in FIGS. 4-6 as well as FIG. 8, in an embodiment of the invention, the front side of the insulating body 1 protrudes outwards to form at to least one stripe limiting block 20. The second fixing part 3 is concave inwards at a position corresponding to the limiting block 20 to form at least one limiting slot 33. When the second fixing part 3 is assembled on the insulating body 1, the limiting block 20 is received in the limiting slot 33, so as to reinforce the assisted positioning of the second fixing part 3. Since the first hook 21 and the second hook 31 as well as the first insertion slot 14 and the second insertion slot 15 are all injection-molded by plastic material, there may be problems in assembly as the materials are of the same kind. In an optimal embodiment of the invention, the front ends of the first hook 21 and the second hook 31 are respectively provided with an inclined surface 25 obliquely extending downwards. The inclined surface 25 is accordingly guided and assembled in the first insertion slot 14 and the second insertion slot 15.

Although the invention has been disclosed with reference to the above embodiments, these embodiments are not intended to limit the invention. It will be apparent to those skilled in the art that various modifications and variations can be made without departing from the scope or spirit of the invention.

Therefore, the scope of the invention shall be defined by the appended claims.

What is claimed is:

1. A card edge connector comprising:
a first fixing part;
a second fixing part;
an insulating body, wherein the first fixing part and the second fixing part are received and arranged on the insulating body;
a plurality of terminals, wherein the plurality of terminals are respectively fixing on the first fixing part and the second fixing part in an insert molding manner;
at least one first hook and at least one second hook respectively disposed on the first fixing part and a second fixing part; and
at least one first insertion slot and at least one second insertion slot inwardly formed in the insulating body in positions corresponding to the first hook and the second hook, wherein the first hook and the second hook are pushed and fastened inwards towards the first insertion slot and the second insertion slot, so that the first fixing part and the second fixing part are assembled and located on the insulating body.

2. The card edge connector of claim 1, wherein the first fixing part comprises at least one first bulge, the second fixing part comprises at least one second bulge, at least one first clamping slot and at least one second clamping slot are formed in the insulating body in positions corresponding to the first bulge and the second bulge, and the first bulge and the second bulge are respectively received and arranged in the first clamping slot and the second clamping slot.

3. The card edge connector of claim 1, wherein the insulating body comprises a plurality of insertion slots, the first fixing part is assembled in the insertion slot from the side surface of the insulating body, and the second fixing part is assembled in the insertion slot from the bottom of the insulating body.

4. The card edge connector of claim 1, wherein the first fixing part comprises at least one matching part, the insulating body comprises at least one groove corresponding to the matching part, a guide surface is formed at the front end of the matching part, and the guiding surface guides the matching part to enter the groove.

5. The card edge connector of claim 1, wherein a front side of the insulating body protrudes outwards to form at least one limiting block, the second fixing part is concave inwards at a position corresponding to the limiting block to form at least one limiting slot, and the limiting block is received in the limiting slot.

6. The card edge connector of claim 1, wherein a front end of the first hook and the second hook are respectively provided with an inclined surface obliquely extending downwards and are accordingly guided and assembled in the first insertion slot and the second insertion slot via the inclined surface.

7. The card edge connector of claim 1, wherein the card edge connector further comprises a pair of ear clips, and the ear clips are respectively arranged in a receiving slot of the insulating body in loose fit.
